(19) United States
(12) Patent Application Publication
(10) Pub. No.: US 2026/0155405 A1
(43) Pub. Date: Jun. 4, 2026

(54) PLATE-TYPE COMPONENT FOR A FUEL CELL STACK, METHOD FOR POSITIONING SAME AND FUEL CELL STACK

(71) Applicant: CELLCENTRIC GMBH & CO. KG, Kirchheim/Teck-Nabern (DE)

(72) Inventors: Wayne DANG, Burnaby, BC (CA); Philipp HAUSMANN, Kirchheim/Teck-Nabern (DE); Tobias SÄNGER, Kirchheim/Teck-Nabern (DE)

(21) Appl. No.: 19/123,643

(22) PCT Filed: Oct. 23, 2023
(86) PCT No.: PCT/EP2023/079450

§ 371 Date: Apr. 23, 2025

(30) Foreign Application Priority Data
Oct. 24, 2022 (DE) 10 2022 211 235.0

(51) Int. Cl. H01M 8/0206; H01M 8/0247; H01M 8/0254; H01M 8/10; H01M 8/12; H01M 8/2457; H01M 8/2475; H01M 8/248

(52) U.S. Cl. CPC H01M 8/0297; G01B 11/002; H01M 8/0247; H01M 8/0273; H01M 8/2404

(57) ABSTRACT

The invention relates to a plate-type component, in particular a separator plate, cathode end plate, anode end plate, half-shell of a separator-, cathode-end-, or anode-end plate or frame for holding a membrane electrode assembly, for a fuel cell stack, wherein a surface of the plate-type component has at least three adjacent regions, forming at least parts of a position marking, and respective neighbouring ones of the at least three adjacent regions are designed in such a way that, when viewing the surface along a predefined direction, the respective neighbouring regions have different average reflectivities at least in the visible region.

The present invention relates to a plate-type component for a fuel cell stack, which has at least one position marking for aligning the plate-type components when stacking the fuel cell stack. The invention also relates to a method for positioning and/or determining a position and/or orientation of at least one plate-type component, in particular for stacking a plurality of plate-type components to form a fuel cell stack according to the invention, as well as to a fuel cell stack having a plurality of plate-type components according to the invention.

In the production of fuel cell stacks, plate-type components are typically stacked. These plate-type components include at least two end plates, in particular cathode and anode end plates, by which the two ends of the stack are formed, and separator plates and membrane electrode assemblies arranged therebetween. Often, the membrane electrode assemblies are already bonded to the separator plates, for example with a frame surrounding the membrane electrode assemblies. The primary aim of stacking the plate-type components is thus to stack these separator plates. These must be positioned precisely relative to one another to ensure that openings in the separator plates, which later form channels for reactants, products and cooling medium running in the stacking direction, are positioned cleanly relative to one another, that the flow fields are reliably aligned, and that seals in the region of the designated surfaces ensure reliable sealing of the plate-type components among one another in the fuel cell stack.

In practice, the plate-type components are often stacked against corresponding stops. This is relatively easy to do with metallic separator plates. This is more difficult with separator plates made of a plastic matrix filled with graphite. Such separator plates are typically formed in molds or dies and cured completely or at least partially in these. In order to be able to demold the manufactured elements reliably, it is necessary that they have so-called demolding slopes on their front sides. This means that when stacked against a stop, only one of the flat sides rests against the stop in the region of its front side. The material there is then correspondingly thin and possibly brittle due to the low material thickness or minimal burrs have formed in this region, in which the parting line of the mold or die is typically located. This leads to damage to the edges during stacking, which is not critical for the function of the separator plate itself, but which makes it extremely difficult to align the individual separator plates to one another using such lateral stops. In addition, broken material particles can get between the plates. This makes it almost impossible to stack the plate-type components tightly.

It is an object of the present invention to provide a plate-type component for a fuel cell stack with which the stacking of the plate-type components can be improved, an improved method for positioning and/or determining a position and/or orientation of at least one plate-type component, and an improved fuel cell stack.

This object is achieved by the features of the independent claims. Advantageous configurations and developments result from the corresponding dependent claims.

A first aspect of the present invention relates to a plate-type component, in some embodiments a separator plate or a cathode end plate or an anode end plate or an intermediate plate or a half-shell of a separator plate, cathode end plate or anode end plate, or a frame for holding a membrane electrode assembly, for a fuel cell stack according to one embodiment, wherein
a surface of the plate-type component has at least three adjacent regions which form at least parts of a position marking, and
respective neighboring ones of the at least three adjacent regions are designed in such a way that, when viewing the surface along a predefined direction, the respective neighboring regions have different average reflectivities at least in the visible range, in one embodiment at least in the visible wavelength range, in one embodiment at a wavelength of 500 nm.

As a result, in one embodiment, the position marking or an image thereof can be detected by means of an optical sensor such as a camera, and based on the detected position marking or the image thereof, a position and/or orientation of the plate-type component in space can be determined, which can be used to align the plate-type components when stacking the plate-type components to form the fuel cell stack. In this way, a stop-free alignment during stacking can take place, which makes stacking the plate-type components easier, largely prevents damage to the edges of the plate-type components and reduces the risk of broken material particles getting between the plate-type components.

Furthermore, since respective neighboring regions of the at least three adjacent regions are designed in such a way that, when viewing the surface along a predetermined direction, the respective neighboring regions have different average reflectivities at least in the visible range, an image of the position marking detected by the optical sensor can have a high contrast, whereby the accuracy in determining the (spatial) position and orientation of the plate-type component can be improved.

Here, in some embodiments, when detecting the image of the position marking by means of the optical sensor, in particular the section of the plate-type component in which the position marking is formed can be irradiated with a light of a predetermined light wavelength or with light within a predetermined light wavelength range, whereby the accuracy in determining the (spatial) position and orientation of the plate-type component can be improved.

Here, at least two of the position markings can be integrated into the surface of the plate-type component in such a way that they are spaced apart from one another. In particular, it is sufficient to provide the position marking(s) on one of the two main surfaces of the plate-type component in order to be able to control the positioning of the individual plate-type component during stacking via the optical sensor. In order to achieve an exact positioning of the plate-type component, relatively large position markings are necessary. It works much better with two position markings that are spaced apart from one another. For this structure, for example, small position markings can be used which are arranged on two opposite sides of the plate-type component, in particular in the region of the two sides spaced further apart from one another, between the side edges of the corresponding plate-type component and a functional surface such as, for example, an opening, a flow field or the like. Due to the relatively large distance, a simple and precise alignment of the plate-type component is easily possible, for example via a camera that detects the position marking(s) and controls an automated depositing device.

The preferred arrangement of the position marking outside the functional surface ensures that it can be implemented independently of the function of the separator plate or the other plate-type components. For example, the position marking can be arranged between the outer edge and corresponding openings or ports for the supply and removal of reactants, products and cooling medium.

In some embodiments, the surfaces of the respective adjacent regions of the at least three adjacent regions have different average roughnesses.

Here, “average roughness” means a macroscopic average roughness. The average roughness depth Rz of one of the two regions, which reflects incident light less strongly, can be 6.3 μm, while the average roughness depth Rz of the other of the two regions can be 2.5 μm.

As a result, it can be achieved in a simple manner, for example by treating/not treating individual surfaces of the respective neighboring ones of the at least three adjacent regions in such a way that they have different average roughnesses or roughness depths, that a high-contrast image of the position marking can be detected by means of the optical sensor.

Here, in one embodiment, the surfaces can be substantially flat surfaces and in another embodiment, coplanar surfaces. In one embodiment, the coplanar surfaces may be parallel to the main surfaces of the plate-type component.

In some embodiments, respective tangents to respective sections of the surfaces of the respective neighboring ones of the at least three adjacent regions have respective different inclinations relative to a normal to a central plane of the plate corresponding to an averaged height profile of the plate-type component. The sections of the surfaces of the respective neighboring regions have, in particular, different inclinations to the main surface of the plate-type component.

As a result, in some embodiments, the individual regions of the position marking can be better distinguished from one another using the image detected by the optical sensor, which can improve the determination of the position of the plate-type component.

Here, at least one of the at least three adjacent regions can be formed by a recess or at least as a part of a recess in the plate-type component, in one embodiment in the main surface thereof. Here, the depth of the recess can be in the range of 0.15 mm to 0.25 mm, in one embodiment 0.22 mm. Such a recess as part of the position marking enables a simple and efficient structure in which nothing protrudes beyond the main surface of the plate-type component, which could potentially have a negative influence on the sealing between the individual plate-type components when stacking them to form the fuel cell stack.

In the event that at least one of the at least three adjacent regions is formed by a recess or at least as part of a recess in the plate-type component, a transition from this region to an adjacent region of the at least three adjacent regions is preferably designed in such a way that a radius of the transition region (seen in the cross section of the plate-type component, in particular in the cross section of the plate-type component perpendicular to the main surface) is in the range from 0.1 mm to 0.2 mm, in one embodiment is 0.15 mm.

In one embodiment, the recess incorporated into the main surface is formed in such a way that its depth, which can be in the range of 0.2 mm to 0.25 mm, in one embodiment is 0.22 mm, is smaller than the thickness of the plate-type component. The recess therefore does not form an opening in the plate-type component, which could also impair the tightness of the structure. Rather, the corresponding section of the position marking is merely incorporated into the material of the plate-type component and can in particular be part of a mold or die in which the corresponding plate-type component is manufactured. Here, the position marking can preferably be formed primarily untreated during tooling, but care must be taken to ensure that the edges of the recess are free of burrs and that any burrs that may occur are removed.

In the case of metallic plate-type components such as, for example, metallic separator plates or end plates, which are preferably installed with separator plates based on carbon material, the region of the position marking formed at least as part of a recess can also be formed in another way, for example as a laser engraving, as an embossing, as a structural element or the like.

As already mentioned, the plate-type components can be separator plates or parts of separator plates, preferably separator plates already connected to an MEA (membrane electrode assembly) or parts, in particular half-shells, of separator plates. In addition, the plate-type components include the corresponding end plates of the fuel cell stack. Additional intermediate plates for sealing individual regions and/or for redirecting or distributing media are of course also conceivable. These plate-type components are then stacked on top of each other and aligned accordingly using the position marking(s) in order to achieve reliable stacking in a simple, efficient manner and with good suitability for large-scale production. This is independent of the geometric configuration of the outer edges, in particular their tolerances and any burrs that may arise during production.

In particular, the separator plates or parts of separator plates can consist of a carbon-containing material and a matrix material, for example of a resin mixed with carbon or the like. This material can be formed and/or cured in a mold or die. The mold contains the entire geometry for the separator plates, such as the functional surfaces on the one hand and the position marking(s) on the other hand, which is represented by an inverse image in the mold and can therefore be placed extremely precisely in relation to the other functional parts of the plate-type components. This creates a high level of precision, which, when using the position marking to align the individual plate-type components during stacking, easily and efficiently leads to high-quality fuel cell stacks.

In some embodiments, respective tangents to the respective sections of the surfaces of two of the at least three adjacent regions which are separated by another region of the at least three adjacent regions may have respective different inclinations relative to the normal to the central plane of the plate.

As a result, in one embodiment, the determination of the position of the plate-type component can be further improved.

In some embodiments, two of the at least three adjacent regions separated by at least one other of the at least three adjacent regions have coplanar surfaces.

This ensures that, assuming the same roughness, the average reflectivity of the two regions with the coplanar surfaces is the same.

In some embodiments, at least one of the three adjacent regions is an annular region.

An annular region designed in this way can enable precise detection and relatively precise alignment of the structure, since a control for arranging position markings in alignment one above the other with at least one annular region can be implemented relatively easily, efficiently and with high accuracy.

In some embodiments, at least one of the three adjacent regions has, in one embodiment, a convex section or a concave section as seen in a cross section of the plate-type component, in particular in the cross section of the plate-type component perpendicular to the main surface.

As a result, in one embodiment, a light ring can be formed in the focal point of the convex or concave section, whereby the contrast of the image of the position marking detected by the optical sensor can be further improved.

In some embodiments, at least three adjacent regions are concentric regions.

As a result, in one embodiment, this allows the determination of the position of the plate-type component to be further improved, since the center of the position marking can be determined more easily using the concentric regions.

In an embodiment in which the at least three adjacent regions are five adjacent circular or annular concentric regions, a diameter of an innermost (circular) of the five regions may be in the range of 2 mm to 2.5 mm, in one embodiment 2.25 mm, while a diameter of a fourth of the five regions viewed radially outward from a center of the position marking may be in the range of 4.5 mm to 5.5 mm, in one embodiment 5 mm.

Furthermore, in this embodiment, a respective angle of inclination of the respective tangent to a respective section of the innermost region, the third region and the fifth region can be in the range of 0° to 5°, in one embodiment 0°, the angle of inclination of the tangent to the section of the second region can be in the range of 10° to 60°, in one embodiment 20°, and the angle of inclination of the tangent to the section of the fourth region can be in the range of 70° to 85°.

Furthermore, in this embodiment, a width or a length of the third region of the at least three adjacent regions can be in the range from 0.4 mm to 0.45 mm, in one embodiment 0.429 mm.

A second aspect of the present invention relates to a method for positioning and/or determining a position and/or orientation of at least one plate-type component described above, in particular for stacking a plurality of plate-type components to form a fuel cell stack, wherein
the position marking on the plate-type component is detected by means of an optical sensor and the position and/or orientation of the plate-type component is determined based on the detected position marking.

Here, in some embodiments, the plate-type component can be positioned based on the determined position and/or orientation of the plate-type component.

Furthermore, in some embodiments, a plurality of the plate-type components can here be stacked to form a fuel cell stack, wherein the alignment of the plate-type components can take place by means of an automated depositing device based on the determined positions and/or orientations of the plate-type components.

The position marking is the same marking in the same position on all plate-type components, so that it can be easily used as a basis for aligning the plate-type components to each other.

A third aspect of the present invention relates to a fuel cell stack having a plurality of plate-type components as described above stacked one above the other.

A fourth aspect of the present invention relates to a computer-implemented method for aligning at least two plate-type components described above on top of each other, which has the following steps:
receiving data having image data of at least one position marking of a first of the at least two plate-type components, detected by means of an optical sensor,
evaluating the detected image data of the at least one position marking of the first plate-type component in order to determine a position and/or orientation of the first plate-type component,
receiving data having image data of at least one position marking of a second of the at least two plate-type components, detected by means of an optical sensor,
evaluating the detected image data of the at least one position marking of the second plate-type component in order to determine a position and/or orientation of the second plate-type component,
comparing the determined positions and/or orientations of the first and second plate-type components, and
outputting a signal to an automated depositing device to cause the automated depositing device to change the position and/or orientation of the second plate-type component in such a way that the first and second plate-type components are stacked one above the other in such a way that their positions and/or orientations are aligned on top of each other.

The features and advantages described with respect to the first aspect of the invention and its advantageous configuration also apply, at least where technically reasonable, to the second aspect, the third aspect and the fourth aspect of the invention and its advantageous configuration, and vice versa.

Further features, advantages and possible applications of the present invention will become apparent from the following description in conjunction with the figures, in which the same reference numerals are used throughout for the same or corresponding elements of the invention. In particular, at least partially schematically:

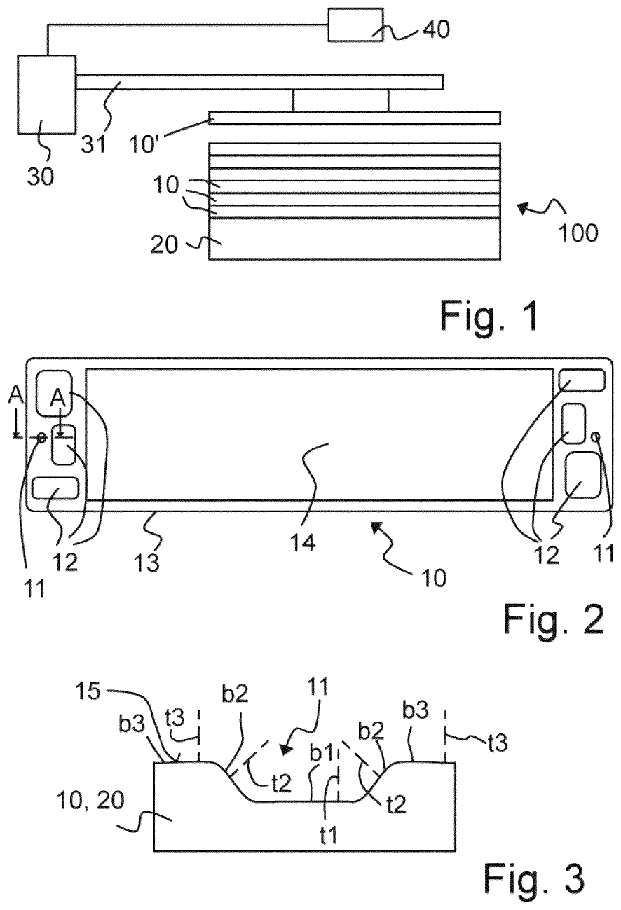

FIG. 1 shows a schematic view of a system for carrying out the method for stacking plate-type components to form a fuel cell stack,

FIG. 2 shows a plan view of a plate-type component for a fuel cell stack according to an embodiment,

FIG. 3 shows a cross-sectional view through a plate-type component illustrated in FIG. 2 according to an embodiment along a section line A-A shown in FIG. 2,

FIG. 4 shows a cross-sectional view through a plate-type component illustrated in FIG. 2 according to another embodiment along the section line A-A shown in FIG. 2, and

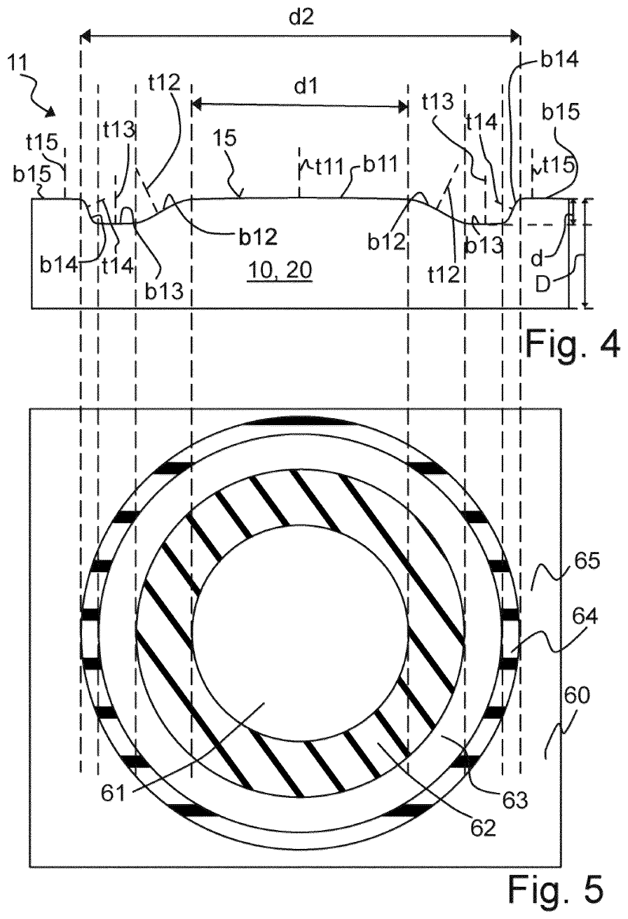

FIG. 5 shows a schematic view of an image detected by means of an optical sensor of the position marking illustrated in FIG. 4.

FIG. 1 shows a schematic view of a system for carrying out the method for stacking plate-type components to form a fuel cell stack according to an embodiment.

Fuel cell stack 100 has at its lower end an end plate 20, in particular a cathode end plate or anode end plate, onto which separator plates 10, in an embodiment with an incorporated membrane electrode assembly, are stacked, optionally after the arrangement of an intermediate plate (not shown here). In another embodiment, the membrane electrode assembly can also be applied to an already positioned separator plate 10 in the method, and then the next separator plate 10 can be arranged or stacked on top of it.

The system for the automated execution of the method is designed as an automated depositing device 30, for example in the form of a robot, which has a gripper arm 31 and is connected to an optical sensor 40, which may for example have a camera, via a communication connection. In the state shown in FIG. 1, a separator plate 10′ has already been picked up by gripper arm 31 from a storage facility (not shown) for plate-type components 10, 20, wherein separator plate 10′is to be stacked on the already stacked part of fuel cell stack 100 in such a way that the plate-type components 10, 20 are aligned with or on top of each other.

For precise positioning of plate-type components 10, 20, these have one or more, in one embodiment two, position markings 11 illustrated in FIG. 2. The system is configured to detect an image of these position marking(s) 11 by means of optical sensor 40, to determine the (spatial) position and orientation of the plate-type components 10, 20 in space based on the detected image, and to control a movement of the gripper arm 31 in such a way that the plate-type component 10, 20 is positioned precisely on the already stacked part of fuel cell stack 100.

In the embodiment shown in FIG. 2, the plate-type component is designed as a separator plate 10. In other embodiments not shown in FIG. 2, the plate-type component can also be designed as a cathode end plate 20, anode end plate 20, intermediate plate, half-shell of a separator plate, cathode end plate or anode end plate, or frame for holding a membrane electrode assembly.

Position markings 11 are arranged within an outer edge 13 of plate-type component 10, 20 in such a way that their position relative to the functional elements of plate-type component 10, 20, which have, for example, openings 12 for the supply and removal of reactants, products and cooling medium as well as a flow field 14 located in the center, is independent of possible tolerances and/or mechanical impairments of these edges 13.

FIG. 3 shows a cross-sectional view through the plate-type component illustrated in FIG. 2 according to an embodiment along a section line A-A shown in FIG. 2, in particular along a position marking formed on the plate-type component.

Position marking 11 or a part thereof has a recess which is incorporated into a main surface 15 of plate-type component 10, 20. Here, the surface of plate-type component 10, 20 has three adjacent circular or annular concentric regions b1, . . . , b3, which are or form parts of position marking 11. In this case, respective neighboring ones of the three adjacent regions b1, . . . , b3 are designed in such a way that, when viewing the surface along a predetermined direction, in particular relative to main surface 15, respective neighboring regions b1, . . . , b3 have different average reflectivities at least in the visible range.

This is achieved in the embodiment illustrated in FIG. 3 in particular in that respective tangents t1, t2, t3 to respective sections of the surfaces of respective neighboring regions b1 and b2 or b2 and b3 have respective different inclinations relative to a normal to a central plane of the plate of plate-type component 10, 20, which corresponds to an averaged height profile of plate-type component 10, 20 and, in one embodiment, runs parallel to main surface 15 of plate-type component 10, 20.

Here, regions b1 and b3, which are separated by region b2, have coplanar surfaces, wherein an inclination angle of tangents t1 and t3 is 0°relative to the normal to the central plane of the plate, and the inclination angle of tangent t2 relative to the normal to the central plane of the plate is about 45°. Furthermore, region b2 has a convex region seen in the cross-sectional direction.

FIG. 4 shows a cross-sectional view through the plate-type component illustrated in FIG. 2 according to another embodiment along the section line A-A shown in FIG. 2, in particular along the position marking formed on the plate-type component.

Position marking 11 or a part thereof has a plurality of recesses which are incorporated into main surface 15 of plate-type component 10, 20 and have a smaller depth d, which can be in the range of 0.2 mm to 0.25 mm, in one embodiment of 0.22 mm, than a thickness D of plate-type component 10, 20.

Here, the surface of plate-type component 10, 20 has three adjacent circular or annular concentric regions b11, . . . , b15, which are or form parts of position marking 11. A diameter d1 of circular innermost region b11 may be in the range of 2 mm to 2.5 mm, in one embodiment 2.25 mm, an outer diameter d2 of annular region b14 may be in the range of 4.5 mm to 5.5 mm, in one embodiment 5 mm, and a width of third annular region b13 viewed radially outward from center of the position mark 11 may be in the range of 0.4 mm to 0.45 mm, in one embodiment 0.429 mm. Furthermore, the transitions between neighboring ones of regions b11, . . . , b15 are designed in such a way that a respective transition region (seen in the cross section of plate-type component 10, 20, in particular in cross section of plate-type component 10, 20 perpendicular to main surface 15) has a radius in the range of 0.1 mm to 0.2 mm, in one embodiment is 0.15 mm.

Respective neighboring ones of five adjacent regions b11, . . . , b15 are designed in such a way that, when viewing the surface along a predefined direction, respective neighboring regions b11, . . . , b15 have different average reflectivities at least in the visible range.

This is achieved in the embodiment illustrated in FIG. 4 in particular in that respective tangents t11, . . . , t15 to respective sections of the surfaces of respective neighboring regions b11, . . . , b15 have respective different inclinations relative to a normal to a central plane of the plate, which corresponds to an averaged height profile of plate-type component 10, 20 and runs parallel to main surface 15.

Here, regions b11, b13 and b15, which are separated by regions b12 and b14, respectively, have coplanar surfaces, wherein an inclination angle of tangents t11, t13 and t15 is 0°, the inclination angle of tangent t12 is in the range of 10° to 60°, in a preferred embodiment is 20°, and the inclination angle of tangent t14 is in the range of 70° to 85°. Furthermore, regions b12 and b14 have a convex region as seen in the cross-sectional direction, and regions b13 have a concave region as seen in the cross-sectional direction.

FIG. 5 shows a schematic view of an image detected by means of an optical sensor of the position marking illustrated in FIG. 4.

Image 60 of position marking 11, which was detected by means of an optical sensor 40 aligned along the predetermined direction, in particular perpendicular to main surface 15, has regions 61, . . . , 65 formed corresponding to regions b11, . . . , b15 of the surface of plate-type component 10, 20, wherein respective neighboring regions 61, . . . , 65 have different brightnesses, so that different regions b11, . . . , b15 of the surface of plate-type component 10, 20 can be clearly distinguished.

In a method for positioning and/or determining a position and/or orientation of at least one plate-type component 10, 20 according to one embodiment, in particular for stacking a plurality of plate-type components 10, 20 to form a fuel cell stack 100, position marking 11 of plate-type component 10, 20 is detected by means of optical sensor 40 and the position and/or orientation of plate-type component 10, 20 is determined based on detected position marking 11.

Here, plate-type component 10, 20 can be positioned based on the determined position and/or orientation of plate-type component 10, 20.

Furthermore, here, a plurality of plate-type components 10, 20 can be stacked to form a fuel cell stack 100, wherein the alignment of plate-type components 10, 20 can take place by means of an automated depositing device 30 based on the determined positions and/or orientations of plate-type components 10, 20.

In a computer-implemented method for aligning at least two plate-type components 10, 20 the following occurs:
receiving data having image data of the at least one position marking 11 of a first of the at least two plate-type components 10, 20, detected by means of optical sensor 40,
evaluating the detected image data of the at least one position marking 11 of first plate-type component 10, 20 in order to determine a position and/or orientation of first plate-type component 10, 20,
receiving data having image data of at least one position marking 11 of a second of the at least two plate-type components 10, 20, detected by means of optical sensor 40,
evaluating the detected image data of the at least one position marking 11 of the second plate-type component 10, 20 in order to determine a position and/or orientation of the second plate-type component 10, 20,
comparing the determined positions and/or orientations of first and second plate-type components 10, 20, and
outputting a signal to the automated depositing device 30 to cause the automated depositing device 30 to change the position and/or orientation of the second plate-type component 10, 20 in such a way that the first and the second plate-type components 10, 20 are stacked one above the other in such a way that their positions and/or orientations are aligned on top of each other.

### LIST OF REFERENCE NUMERALS

10 separator plate

11 position marking

12 opening

13 outer edge

14 flow field

15 main surface of the plate-type component

20 end plate

30 automated depositing device

31 gripper arm

40 optical sensor

60 image of the position marking

61, . . . , 65 regions of the position marking image

b1, . . . , b3; b11, . . . , b15 regions of the surface of the plate-type component

t1, . . . , t3; t11, . . . , t15 tangents to regions of the surface of the plate-type component

d1, d2 diameter of circular or annular regions of the surface of the plate-type component

d depth of the recess

D thickness of the plate-type component

What is claimed is:

1. A plate-type component, in particular a separator plate, cathode end plate, anode end plate, half-shell of a separator, cathode end plate or anode end plate, or frame for holding a membrane electrode assembly, for a fuel cell stack, wherein
a surface of the plate-type component has at least three adjacent regions (b1, . . . , b3; b11, . . . , b15) forming at least parts of a position marking and
respective neighboring ones of the at least three adjacent regions (b1, . . . , b3; b11, . . . , b15) are designed in such a way that, when viewing the surface along a predefined direction, the respective neighboring regions (b1, . . . , b3; b11, . . . , b15) have different average reflectivities at least in the visible range.

2. The plate-type component according to claim 1, wherein the surfaces of the respective neighboring ones of the at least three adjacent regions (b1, . . . , b3; b11, . . . , b15) have different average roughnesses.

3. The plate-type component according to claim 1, wherein respective tangents (t1, . . . , t3; t11, . . . , t15) to respective sections of the surfaces of the respective neighboring ones of the at least three adjacent regions (b1, . . . , b3; b11, . . . , b15) have respective different inclinations relative to a normal to a central plane of the plate corresponding to an averaged height profile of the plate-type component.

4. The plate-type component according to claim 3, wherein respective tangents (t1, . . . , t3; t11, . . . , t15) to the respective sections of the surfaces of two of the at least three adjacent regions (b1, . . . , b3; b11, . . . , b15) which are separated by another region of the at least three adjacent regions (b1, . . . , b3; b11, . . . , b15) have respective different inclinations relative to the normal to the central plane of the plate.

5. The plate-type component according to claim 1, wherein two of the at least three adjacent regions (b1, . . . , b3; b11, . . . , b15), which are separated by at least one other of the at least three adjacent regions (b1, . . . , b3; b11, . . . , b15), have coplanar surfaces.

6. The plate-type component according to claim 1, wherein at least one region of the three adjacent regions is an annular region.

7. The plate-type component according to claim 1, wherein at least one of the three adjacent regions (b1, . . . , b3; b11, . . . , b15) has a convex section or a concave section.

8. The plate-type component according to claim 1, wherein the at least three adjacent regions (b1, . . . , b3; b11, . . . , b15) are concentric regions.

9. A method for positioning and/or determining a position and/or orientation of at least one plate-type component according to claim 1, in particular for stacking a plurality of plate-type components to form a fuel cell stack, wherein
the position marking on the plate-type component of is detected by means of an optical sensor and the position and/or orientation of the plate-type component determined based on the detected position marking.

10. The method according to claim 9, wherein the plate-type component is positioned based on the determined position and/or orientation of the plate-type component.

11. The method according to claim 9, wherein a plurality of the plate-type components are stacked to form a fuel cell stack, and wherein the alignment of the plate-type components takes place by means of an automated depositing device based on the determined positions and/or orientations of the plate-type components.

12. A fuel cell stack, having a plurality of plate-type components stacked one above the other according to claim 1.

13. A computer-implemented method for aligning at least two plate-type components according to claim 1, on top of each other, having the steps of:
receiving data having image data of at least one position marking of a first of the at least two plate-type components, detected by means of an optical sensor,
evaluating the detected image data of the at least one position marking of the first plate-type component in order to determine a position and/or orientation of the first plate-type component,
receiving data having image data of at least one position marking of a second of the at least two plate-type components, detected by the optical sensor,
evaluating the detected image data of the at least one position marking of the second plate-type component in order to determine a position and/or orientation of the second plate-type component,
comparing the determined positions and/or orientations of the first and second plate-type components, and
outputting a signal to an automated depositing device to cause the automated depositing device to change the position and/or orientation of the second plate-type component in such a way that the first and second plate-type components are stacked one above the other in such a way that their positions and/or orientations are aligned on top of each other.

14. The plate-type component according to claim 2, wherein respective tangents (t1, . . . , t3; t11, . . . , t15) to respective sections of the surfaces of the respective neighboring ones of the at least three adjacent regions (b1, . . . , b3; b11, . . . , b15) have respective different inclinations relative to a normal to a central plane of the plate corresponding to an averaged height profile of the plate-type component.

15. The plate-type component according to claim 2, wherein two of the at least three adjacent regions (b1, . . . , b3; b11, . . . , b15), which are separated by at least one other of the at least three adjacent regions (b1, . . . , b3; b11, . . . , b15), have coplanar surfaces.

16. The plate-type component according to claim 2, wherein at least one region of the three adjacent regions is an annular region.

17. The plate-type component according to claim 2, wherein at least one of the three adjacent regions (b1, . . . , b3; b11, . . . , b15) has a convex section or a concave section.

18. The plate-type component according to claim 2, wherein the at least three adjacent regions (b1, . . . , b3; b11, . . . , b15) are concentric regions.

19. A method for positioning and/or determining a position and/or orientation of at least one plate-type component according to claim 2, in particular for stacking a plurality of plate-type components to form a fuel cell stack, wherein the position marking on the plate-type component of is detected by means of an optical sensor and the position and/or orientation of the plate-type component is determined based on the detected position marking.

20. The method according to claim 10, wherein a plurality of the plate-type components are stacked to form a fuel cell stack, and wherein the alignment of the plate-type components takes place by means of an automated depositing device based on the determined positions and/or orientations of the plate-type components.
